(19) United States
(12) Patent Application Publication
(10) Pub. No.: US 2003/0019886 A1
(43) Pub. Date: Jan. 30, 2003

(54) Customer interface for a beverage dispenser

(75) Inventors: Thomas J. Chadwell, San Antonio, TX (US); David C. Sudolcan, Atascosa, TX (US)

Correspondence Address: CHRISTOPHER L. MAKAY, LAW OFFICES, 1634 Milam Building, 115 East Travis Street, San Antonio, TX, 78205, US

(73) Assignee: Lancer Partnership. Ltd

(21) Appl. No.: 09/766,283

(22) Filed: Jan. 19, 2001

(51) Int. Cl. B67D 5/56

(52) U.S. Cl. 222/129.1; 222/1; 222/63

(57) ABSTRACT

A beverage dispenser includes a customer interface and a logic unit for controlling beverage dispenser operations. The customer interface includes a sensor linked with the logic unit. Specifically, the sensor receives an input and outputs a corresponding command signal. The logic unit receives the corresponding command signal from the sensor and thus controls beverage dispenser operations.

### BACKGROUND OF THE INVENTION

1. Field of the Invention

The present invention generally relates to dispensing equipment and, more particularly, but not by way of limitation, to a customer interface for a beverage dispenser.

2. Description of the Related Art

Soft drink beverage dispensers are growing in popularity and availability. From fast-food restaurants to multiplex movie theaters, the use of soft drink beverage dispensers is expanding into many new commercial markets. As a result, more people than ever before enjoy today's convenience of selecting a beverage of choice from an array of different drink flavors.

Typically, beverage dispensers feature a dispensing valve assembly for supplying a drink therefrom. The dispensing valve assembly includes several dispensing valves for providing an array of different drink flavors, whereby each dispensing valve is often assigned a single drink flavor.

By placing a cup thereunder and activating a dispensing valve, the beverage dispenser dispenses the desired flavored drink into the cup at a preset volume and temperature. In particular, beverage fluids within the beverage dispenser are each carried from a respective beverage fluid source to the desired dispensing valve of the dispensing valve assembly. Beverage fluids are, thus, often combined as they pass through the dispensing valve to form the desired flavored drink.

A customer interfaces with the beverage dispenser and inputs desired flavored drink selections to the dispensing valve assembly through membrane switches of a type well known in the industry. Beverage dispenser operations, such as administering a drink with a desired flavor and volume, are thus selectively controlled by manually depressing membrane switches.

Unfortunately, membrane switches are wear sensitive and present a problem in varying texture and tactile feel. Commonly, membrane switches are plastic and maintain a “bubble-like” configuration so as to collapse when depressed, hence providing a “push-button” feel. When subjected to a large volume of customers, membrane switches often become wrinkled and wavy. Also with continuous use, the color of membrane switches becomes dull and difficult to color match with adjacent panels and substrates. Further, the edges about membrane switches trap dirt. Besides cleaning problems, dirt can interfere with corresponding electronic signals emitted by the membrane switch.

Accordingly, there is a long felt need for a customer interface that can reliably accommodate the individual demands of a large volume of customers through selective control of beverage dispenser operations.

### SUMMARY OF THE INVENTION

In accordance with the present invention, a beverage dispenser includes a customer interface and a logic unit for controlling beverage dispenser operations. The customer interface includes a sensor linked with the logic unit. Specifically, the sensor receives an input and outputs a corresponding command signal. The logic unit receives the corresponding command signal from the sensor and thus controls beverage dispenser operations.

The sensor establishes an RF field responsive to a range of dielectric materials, such as for example the human body. Thus, the sensor detects disruptions in the established RF field by a dielectric material and outputs the corresponding command signal. Accordingly, a customer provides an input without physically touching the sensor so that complications associated with physically touching current membrane switches are circumvented.

In accordance with the present invention, a method for operating a beverage dispenser includes providing a customer interface having a sensor coupled with a logic unit that receives an input and outputs a corresponding command signal. The sensor receives an input and outputs a corresponding command signal to the logic unit. The sensor receives an input by establishing an RF field and detecting a disruption in the established RF field by a dielectric material. The logic unit controls beverage dispenser operations utilizing the corresponding command signal.

It is therefore an object of the present invention to provide a beverage dispenser for reliably receiving consumer input despite continuous and heavy use thereof.

It is therefore a further object of the present invention to provide a customer interface that receives input for selectively controlling beverage dispenser operations.

Still other objects, features, and advantages of the present invention will become evident to those of ordinary skill in the art in light of the following.

### BRIEF DESCRIPTION OF THE DRAWINGS

FIG. 1 is a perspective view illustrating a beverage dispenser featuring a customer interface for selectively controlling beverage dispenser operations.

FIG. 2 is a schematic diagram illustrating a customer interface panel of the customer interface of FIG. 1 electrically engaged with a dispensing valve assembly.

### DETAILED DESCRIPTION OF THE PREFERRED EMBODIMENT

As required, detailed embodiments of the present invention are disclosed herein, however, it is to be understood that the disclosed embodiments are merely exemplary of the invention, which may be embodied in various form; the figures are not necessarily to scale; and some features may be exaggerated to show details of particular components or steps.

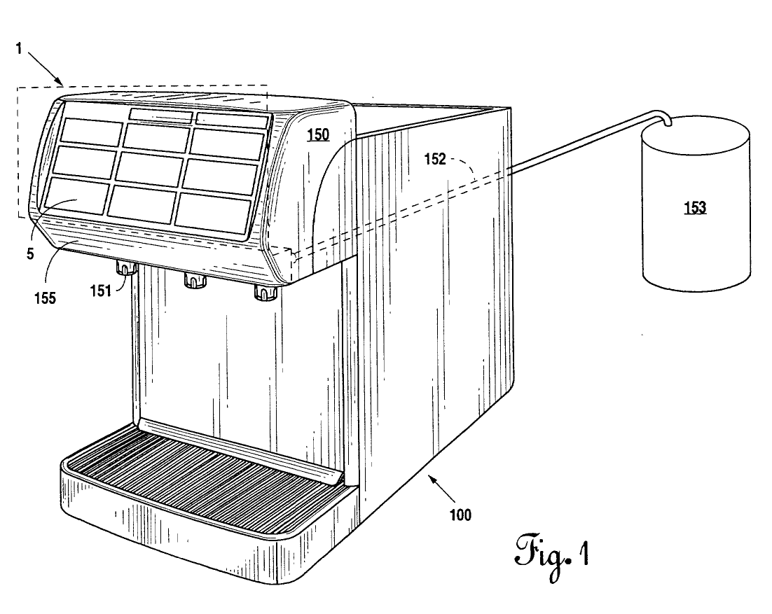

FIG. 1 illustrates a beverage dispenser 100 for dispensing a desired beverage therefrom. The beverage dispenser 100 is of a type widely known in the industry, preferably for dispensing commercial beverages such as soft drinks, coffee, and juices. The beverage dispenser 100 includes a dispensing valve assembly 150 for dispensing the desired beverage to a customer.

In particular, the dispensing valve assembly 150 includes at least one dispensing valve 151 for discharging a desired beverage directly therefrom. In the preferred embodiment, the dispensing valve 151 may be any well-known valve such as an electric dispensing valve or multi-flavored dispensing valve available from Lancer Corporation, 6655 Lancer Blvd., San Antonio, Tex. 78219. Those of ordinary skill in the art, however, will recognize other suitable embodiments of the dispensing valve assembly 150 so long as a desired beverage is dispensed therefrom.

Preferably, the dispensing valve assembly 150 includes a plurality of dispensing valves for increasing drink flavor variety. The dispensing valve assembly 150 further includes a valve assembly housing 155 extending from the beverage dispenser 100 for housing at least one dispensing valve 151 therein.

Operatively, by placing a cup (not shown) thereunder and activating the dispensing valve 151, the beverage dispenser dispenses a desired flavored beverage into the cup. Inasmuch, within the beverage dispenser 150, beverage fluids, such as flavored syrup, diluent (e.g., carbonated water and plain water) and flavor additives (e.g., cherry and vanilla) are each carried, via a designated beverage fluid line 152, from a respective beverage fluid source 153 to the dispensing valve 151. In the preferred embodiment, the beverage dispenser 100 combines beverage fluids as they pass through the dispensing valve 151, thereby forming the desired flavored drink.

The beverage dispenser 100 includes a customer interface 1 secured to the valve assembly housing 155 for facilitating for the activation of a desired dispensing valve in accordance with individual customer demands. Moreover, via direct customer input, the customer interface 1 selectively controls beverage dispenser operations, thereby reliably accommodating individual demands of a large number of customers over extended periods of use.

For the beverage dispenser 100, the customer interface 1 is electrically linked with at least one dispensing valve 151 of the dispensing valve assembly 150 for selectively controlling beverage dispensing operations therefrom. Those of ordinary skill in the art will readily recognize the application of a customer interface with other elements of a beverage dispenser requiring consumer input, such as for example a customer interface for controlling ice dispensing or for administering merchandising information. As such, the customer interface 1 may include indicia designating the operational significance of the touch control interface, such as the words “drink selector”, or any merchandising information.

The customer interface 1 includes at least one customer interface panel 5 for receiving customer input. The preferred customer interface 1 includes three customer interface panels 5 per dispensing valve 151 as shown in FIG. 1. Thus, in particular, each dispensing valve 151 features three customer interface panels 5, each indicating a different beverage flavor, such as, cola, diet cola, or orange soda. Each customer interface panel 5 may include indicia designating the operational significance of that customer interface panel 5, whereby, for example, one customer interface panel may indicate the word “cola”, another panel the word “diet cola”, and another panel the word “orange” in reference to a desired beverage to be dispensed. Illustratively, for a customer interface indicating drink flavor selection on each customer interface panel, activating a customer interface panel indicating the words “cola” will thus dispense that desired beverage from a designated dispensing valve. It should be added that those of ordinary skill in the art will recognize other suitable configurations for a customer interface so that it features one or more panels, each panel for receiving consumer input and for facilitating operations of the beverage dispenser 100.

Furthermore, each customer interface panel 5 preferably allows a customer to select a desired preset volume of beverage to be dispensed, such as for example a small, medium, large, or extra large portion. Continuing with the example above, in accordance with customer input on the customer interface panel 5 regarding beverage volume, a consumer with a “medium sized” cup may obtain a corresponding quantity of cola by activating the customer interface panel 5.

Each customer interface panel 5 may also feature a manual override option allowing continuous customer control over the exact volume of beverage to be dispensed. Those of ordinary skill in the art will recognize other suitable inputs for operating the dispensing valve assembly 150 using each customer interface panel 5, such as for example dispensing flavor additives (e.g., cherry and vanilla) into a desired beverage, such as cola.

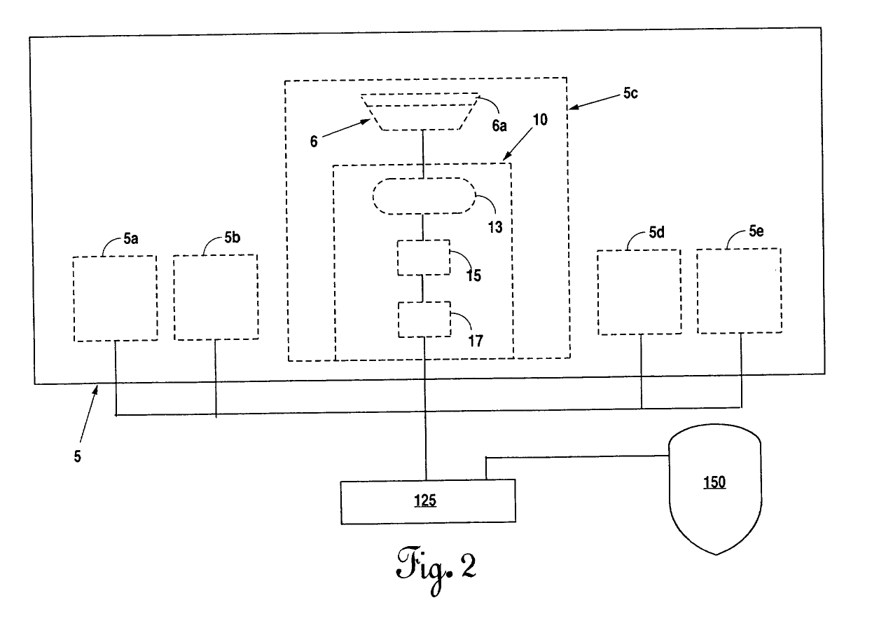

FIG. 2 schematically illustrates the customer interface panel 5 electrically coupled with the dispensing valve assembly 150. As such, the beverage dispenser 100 includes a logic unit 125 electrically linked with the customer interface panel 5 and with the dispensing valve assembly 150 for receiving an input from the customer interface panel 5 and controlling the dispensing valve assembly 150 accordingly. Although those of ordinary skill in the art will recognize other means for controlling beverage dispenser operations, the logic unit 125 in the preferred embodiment is a standard microprocessor of a type well known in the industry.

Specifically, with regard to indicating a desired preset volume or manual override, the customer interface panel 5 in FIG. 2 includes a first input zone 5a, a second input zone 5b, a third input zone 5c, a fourth input zone 5c, and a fifth input zone 5e. Each of the input zones 5a-5e provides switch-like characteristics and is triggered through a customer interface therewith to provide a command signal corresponding to a desired preset volume or manual override. The logic unit 125 receives the command signal from the particular input zone 5a-5e and activates the dispensing valve assembly 150 according to the command signal, thereby dispensing a desired preset volume or providing a continuous dispense.

In this manner, those of ordinary skill in the art will readily recognize that the logic unit 125 may control other beverage dispenser operations via input zones. Moreover, those of ordinary skill in the art will recognize other suitable configurations for one or more input zones on a customer interface panel, whereby each input zone receives customer input.

Inasmuch, the first input zone 5a is provided for receiving a first input indicating that a first desired preset volume of beverage is desired, such as for a “small” sized cup. The second input zone 5b is provided for receiving a second input indicating that a second desired preset volume of beverage is desired, such as for a “medium” sized cup. The third input zone 5c is provided for receiving a third input indicating that a third desired preset volume of beverage is desired, such as for a “large” sized cup. The fourth input zone 5d is provided for receiving a fourth input indicating that a fourth desired preset volume of beverage is desired, such as for an “extra large” sized cup. The fifth input zone 5e is provided for receiving a fifth input indicating a manual override option. The manual override option consists of continuously subjecting a corresponding input zone, such as the fifth input zone 5e, to a customer interface thereof, thereby activating a desired dispensing valve.

Each input zone 5a-5e includes a sensor electrically linked with the logic unit 125 for determining a customer input. Illustratively, the input zone 5c includes a sensor 10 that establishes an RF field responsive to a particular range of dielectric materials including but not limited to that of the human body (e.g., a finger). As such, after establishing an RF field, the sensor 10 determines a customer input through detecting the disruption of the established RF field caused by the introduction of a dielectric material into the established RF field. Responsive to the detection of a disruption in the established RF field through the introduction of a dielectric material thereto, the sensor 10 outputs a command signal corresponding to a desired preset volume or manual override to the logic unit 125. It should be understood by those of ordinary skill in the art that directly touching the sensor 10 is not required to produce a customer input. Furthermore, the configurations of the other input zones will not be described herein as they are identical to the third input zone 5c, which schematically portrays the preferred configuration of the input zone sensors.

The third input zone 5c includes an indicator 6 which provides a visual medium that guides the customer into the area of the customer interface panel 5 including the established RF field of the sensor 10, thereby allowing the customer to disrupt the established RF field and produce an output from the sensor 10. The indicator 6 thus provides an area that permits the customer to directly touch the customer interface panel 5 and provide an input thereof, although directly touching the customer interface panel 5 is not required. The indicator 6 is preferably positioned about the sensor 10 to protect the sensor 10 from wear as well as from unfavorable exposure to the atmosphere. The indicator 6 may further include a face plate 6a having indicia designating the operational significance of the third input zone 5c, such as “large drink size”. Thus, operatively, a consumer desiring a large drink engages the indicator 6, thereby disrupting the RF field established by the sensor 10.

Although those of ordinary skill in the art may contemplate other well-known sensors for the sensor 10, the sensor 10 preferably comprises a SENS-A-TOUCH RF field sensor available from TouchSensor Technologies of Wheaton, Ill. and described in U.S. Pat. No. 5,594,222 to Caldwell. As shown in FIG. 2, the sensor 10 includes an antenna 13 for conveying the established RF field. The sensor 10 further includes an application specific integrated circuit 15 and a signal modifier 17. The application specific integrated circuit 15 electrically links with the antenna 13 and establishes the RF field carried by the antenna 13. The application specific integrated circuit 15 further determines a customer input through the detection of a disruption in the established RF field resulting from the introduction of a dielectric material into the established RF field (e.g., a finger of a human body). Responsive to the detection of a disruption in the established RF field, the application specific integrated circuit 15 outputs a command signal to the signal modifier 17, which configures the command signal for optimal reception by the logic unit 125, thereby providing the logic unit 125 with the command signal. Unlike current membrane switches, sensor 10 requires no moving parts, thereby providing a solid-state means for receiving consumer input thereon.

In operation, a customer operates the beverage dispenser 100 via the customer interface 1 by engaging an input zone 5a-5e on the customer interface panel 5, thereby designating a desired drink flavor and volume to be dispensed. The engaged sensor within an input zone 5a-5e provides a command signal received by the logic unit 125, which activates a corresponding dispensing valve 151 from the dispensing valve assembly 150, whereby a desired beverage is discharged therefrom.

Although the present invention has been described in terms of the foregoing embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing description; rather, it is defined only by the claims that follow.

I claim:

1. A beverage dispenser, comprising:
a logic unit that controls beverage dispenser operations; and
a customer interface including a sensor coupled with the logic unit that receives an input and outputs a corresponding command signal.

2. The beverage dispenser according to claim 1 wherein the sensor establishes an RF field.

3. The beverage dispenser according to claim 2 wherein the sensor outputs the corresponding command signal responsive to the detection of a disruption in the established RF field by a dielectric material.

4. The beverage dispenser according to claim 1 wherein the logic unit receives the corresponding command signal from the sensor and controls beverage dispenser operations accordingly.

5. The beverage dispenser according to claim 1 wherein the customer interface includes an indicator disposed about the sensor.

6. The beverage dispenser according to claim 1 wherein the logic unit comprises a microprocessor.

7. The beverage dispenser according to claim 1 further comprising a dispensing valve assembly for discharging a desired beverage therefrom.

8. The beverage dispenser according to claim 1 wherein the logic unit is coupled with the dispensing valve assembly and controls the dispensing valve assembly in the dispensing of a desired beverage therefrom in accordance with the corresponding command signal.

9. The beverage dispenser according to claim 1 wherein the customer interface includes a customer interface panel housing the sensor.

10. The beverage dispenser according to claim 1 wherein the sensor comprises:
an antenna that carries an established RF field; and
an application specific integrated circuit coupled with the antenna, wherein the application specific integrated circuit establishes the RF field carried by the antenna, and further wherein the application specific integrated circuit outputs a corresponding command signal responsive to the detection of a disruption in the established RF field by a dielectric material.

11. The beverage dispenser according to claim 10 wherein the sensor further comprises a signal modifier that configures the corresponding command signal for optimal reception by the logic unit.

12. A method for operating a beverage dispenser, comprising the steps of:
providing a customer interface including a sensor coupled with a logic unit that receives an input and outputs a corresponding command signal;
receiving input via the sensor;
outputting a corresponding command signal to the logic unit via the sensor; and
controlling beverage dispenser operations via the logic unit utilizing the corresponding command signal.

13. The method for operating a beverage dispenser according to claim 12 wherein the step of receiving input via the sensor, comprises the steps of:
establishing an RF field; and
detecting a disruption in the established RF field by a dielectric material.

14. The method for operating a beverage dispenser according to claim 12 further comprising the step of providing a dispensing valve assembly for discharging a desired beverage therefrom.

15. The method according to claim 14 further comprising the steps of:
interpreting the corresponding command signal, via the logic unit, as a command for controlling the dispensing valve assembly; and
activating a dispensing valve of the dispensing valve assembly to dispense the desired drink pursuant to the corresponding command signal.
